(19) United States
(12) Patent Application Publication
(10) Pub. No.: US 2026/0061351 A1
(43) Pub. Date: Mar. 5, 2026

(54) FILTRATION SYSTEM WITH ADDITIVE

(71) Applicant: Cummins Filtration Inc., Nashville, TN (US)

(72) Inventors: Caleb Wilson, Cookeville, TN (US); Jonathan D. Sheumaker, Cookeville, TN (US); Eduardo Javier Pereira, Cambridge, MA (US); Anthony Joseph Huth, Cincinnati, OH (US); Corey W. Trobaugh, Southlake, TX (US); Billy M. Bates; Natashia J. Bass, Cookeville, TN (US)

(73) Assignee: Cummins Filtration Inc., Nashville, TN (US)

(21) Appl. No.: 19/105,290

(22) PCT Filed: Aug. 26, 2022
(86) PCT No.: PCT/US2022/041646

§ 371 Date: Feb. 20, 2025

(51) Int. Cl. B01D 37/02; B01D 29/15

(52) U.S. Cl. CPC B01D 37/025; B01D 29/15; B01D 2201/0415

(57) ABSTRACT

A system includes a housing. The system includes a filter element disposed in the housing. The filter element is configured to filter an operating fluid. The system includes an additive disposed in the housing. The additive is configured as a crystalline solid at a temperature below 60° C. and configured to disperse into an operating fluid at a temperature in a range of 60° C. to 160° C. The additive can improve the oxidative stability of the operating fluid.

### TECHNICAL FIELD

The present disclosure relates generally to filtration systems for filtering fluids such as lube oil.

### BACKGROUND

Internal combustion engines generally combust a mixture of fuel (e.g., diesel, gasoline, natural gas, etc.) and air. Prior to entering the engine, various fluids, including the fuel and lube oil, is typically passed through a filter element to remove particulate matter (e.g., dust, metal particles, debris, etc.).

### SUMMARY

Embodiments described herein relate generally to systems that include a housing and an additive disposed in the housing. The additive is configured as a crystalline solid at a temperature below 60° C. and is configured to disperse into the operating fluid at a temperature in a range of 60° C. to 160° C. In various embodiments, the use of an additive as disclosed herein can result in benefits such as increased oil life, reduced costs, and being more environmentally friendly than in other conventional systems without such an additive.

In various embodiments, the system includes a filter element disposed within the housing. In some embodiments, the additive is coupled with the filter element. In some embodiments, the filter element comprises an endplate and the additive is coupled with the endplate of the filter element. In some embodiments, the filter element defines a hollow interior and the additive is disposed within the hollow interior of the filter element. In some embodiments, the system comprises a tube disposed in the filter element and the additive is disposed in the tube. In some embodiments, the filter element comprises an influent side and an effluent side. The additive is disposed on at least one of the influent side of the filter element or the effluent side of the filter element.

In some embodiments, the additive comprises at least one of an aminic antioxidant, a phenolic antioxidant, an anti-wear additive, a pour point depressant, a viscosity modifier, a friction modifier, a dispersant, an over-based detergent, a weak based additive, an anti-foam additive, a corrosion inhibitor additive, or a surfactant. In some embodiments, the additive is ashless. In some embodiments, the additive comprises a surfactant such as docusate sodium or Aerosol OT. In some embodiments, the operating fluid comprises at least one of lube oil, hydraulic fluid, gear oil, and coolant.

In some embodiments, the additive is configured to react with hydrocarbon free radicals in the operating fluid. In some embodiments, the additive comprises a powder. In some embodiments, the additive is disposed in a fibrous matrix.

Another aspect of the present disclosure is direct to a filter element. The filter element includes a filter media. The filter element includes an additive coupled with the filter media. The additive configured as a crystalline solid at a temperature below 60° C. and configured to disperse into an operating fluid at a temperature in a range of 60° C. to 160° C.

In some embodiments, the filter element comprises a hollow interior and the additive is disposed within the hollow interior of the filter element. In some embodiments, the filter element comprises a tube disposed in the filter element and the additive is disposed in the tube. In some embodiments, the filter element comprises an endplate and the additive is coupled with the endplate of the filter element. In some embodiments, the filter element comprises an influent side and an effluent side. The additive is disposed on at least one of the influent side of the filter element or the effluent side of the filter element.

In some embodiments, the additive is configured to react with hydrocarbon free radicals in the operating fluid. In some embodiments, the operating fluid comprises at least one of lube oil, hydraulic fluid, gear oil, and coolant.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a cross-sectional view of a system for filtering, according to an embodiment.

FIG. 2 illustrates a perspective view of a filter element, according to an embodiment.

FIG. 3 illustrates a cross-sectional perspective view of a lower portion of the filter element of FIG. 2.

FIG. 4 illustrates a cross-sectional perspective view of the filter element of FIG. 2.

FIG. 5 illustrates a cross-sectional view of a portion of a system for filtering, according to another embodiment.

FIG. 6 illustrates an exploded view of the system portion of FIG. 5.

FIG. 7 illustrates a differential scanning calorimetry plot of an additive, according to an embodiment.

Like reference numbers and designations in the various drawings indicate like elements.

### DETAILED DESCRIPTION

Following below are more detailed descriptions of various concepts related to, and implementations of, methods, apparatuses, and systems for a filter system including an additive. The various concepts introduced above and discussed in greater detail below may be implemented in any of a number of ways, as the described concepts are not limited to any particular manner of implementation. Examples of specific implementations and applications are provided primarily for illustrative purposes.

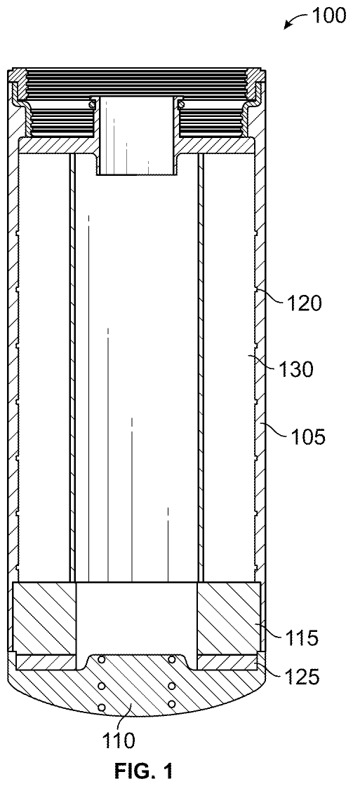

FIG. 1 illustrates a cross-sectional view of an example system 100 (e.g., additive system) for filtering a fluid. The system 100 includes a housing 105 (e.g., vessel). The housing 105 can be directly or indirectly coupled with an engine. For example, the housing 105 can be mounted on or near the engine. The housing 105 can be in the form of a spin-on filter shell, a filter cartridge housing, a centrifuge housing, or a filtration module assembly.

The system 100 includes an additive 110. The additive 110 is disposed in the housing 105. The housing 105 can be fluidly coupled with the engine. For example, the additive 110 can mix with fluid in the engine. The additive 110 can release into the fluid in the engine during the operation of the engine.

The additive 110 is configured as a crystalline solid at a temperature below 60° C. The additive 110 can be a chemical additive (e.g., solid chemical additive). For example, the additive 110 can be a solid additive below 60° C. In solid form, the additive 110 may not flow, creep, or weep at a temperature below 60° C. for a period of time (e.g., 48 hours, 72 hours, 144 hours, etc.). The additive 110 can be a crystalline solid, in contrast to a gel, liquid, paste, or wax.

The additive 110 is configured to disperse into an operating fluid at a temperature in a range of 60° C. to 160° C. (e.g., 60° C., 70° C., 80° C., 90° C., 100° C., 110° C., 120° C., 130° C., 140° C., 150° C., 160° C., etc.). For example, the additive 110 can be configured as a liquid at a temperature in a range of 60° C. to 160° C. The operating fluid 115 can be located in the engine. The operating fluid 115 has a temperature in the range of 60° C. to 160° C. The additive 110 can be soluble in the operating fluid 115. The additive 110 can dissolve in the operating fluid 115. For example, the additive 110 can dissolve in the operating fluid 115 during operating conditions (e.g., when the engine is running). The additive 110 can improve oxidative stability of the operating fluid 115. The operating fluid 115 can comprise, for example, lube oil, hydraulic fluid, gear oil, fuel and coolant.

The additive 110 can dissolve into the operating fluid 115 during operating conditions. The release rate of the additive 110 can be a function of operating conditions, geometry, additive consistency, and additive location within the housing 105. The additive 110 that is located within filter media can exhibit a fast release rate because the additive 110 can have a large amount of surface area that is exposed to the flowing operating fluid 115. In this case, a fast release rate can include a situation in which at least 90% of the additive 110 is dissolved into the fluid within 20 hours of service or less. Additive that is located within the inner diameter (ID) of a filter element can exhibit a fast release rate because the additive 110 can have a large amount of surface area that is exposed to the flowing operating fluid 115. In this case, a fast release rate can include a situation in which at least 90% of the additive 110 is dissolved into the fluid in 30 hours of service or less. Additive 110 that is located below a lower endplate of a filter element can exhibit a slow release rate due to the lower amount of additive surface area exposed to the fluid flow and the relatively quiescent area below the endplate. In this case, a slow release rate can include a situation in which at least 90% of the additive 110 is dissolved into the fluid in as few as 30 hours and up to as many as 500 hours or more.

The additive 110 can include at least one of an aminic antioxidant, a phenolic antioxidant, an anti-wear additive, a pour point depressant, a viscosity modifier, a friction modifier, a dispersant, an over-based detergent, a weak based additive, an anti-foam additive, a corrosion inhibitor additive, or a surfactant. The additive 110 can include a surfactant such as docusate sodium Aerosol OT (sodium bis(2-ethylhexyl) sulfosuccinate). In particular embodiments, the additive 110 can melt between a temperature of 60° C. and 160° C. (inclusive).

The additive 110 can be ashless. Ashless additives can reduce negative impacts on engine systems, aftertreatment systems, fuel economy, and the environment. Ashless additives can reduce or eliminate deposits within the engine due to the presence of the additive 110. In applications using aftertreatment systems, this can reduce or eliminate ash that could become trapped within the aftertreatment components due to the presence of the additive 110. Ashless additives can provide a fuel economy benefit over using ash-containing additives by lowering the frequency of aftertreatment regeneration cycles needed to maintain low back pressure in the aftertreatment systems. The absence of ash in the chemical additive can benefit the environment by lowering CO₂ emissions as a result of lower fuel consumption. In applications that do not use aftertreatment systems, the use of ashless additives can reduce or eliminate ash exhausted to the environment due to the presence of the chemical additive. An ashless additive can include an additive that does not include ash.

The additive 110 can include a powder, solid, or liquid. For example, the additive 110 can be a powder, solid, or liquid before the additive 110 is disposed in the housing 105. The additive 110 can be a solid after the additive 110 is disposed in the housing 105. The additive 110 can be retained in the housing 105 during packaging, shipping, storage, and/or installation of the system 100. The additive 110 can contain itself within the housing 105 without an additional container or dosing mechanism.

The additive 110 can improve or maintain quality of the operating fluid 115. In this case, a change in fluid quality can refer to a change in molecular structure of the fluid that impacts the fluid's intended functions. When dissolved in the operating fluid 115, the additive 110 can improve resistance to oxidation by introducing a compound that reacts with hydrocarbon free radicals at a faster rate than the operating fluid 115. For example, the additive 110 can react with hydrocarbon free radicals in the operating fluid 115. Increased intermolecular attraction between the additive 110 and hydrocarbon radicals in solution can quench hydrocarbon radicals, forming them into less harmful functional groups, and decrease the rate of oxidation of the operating fluid 115.

The additive 110 could have a sacrificial function. For example, the additive 110 can react with hydrocarbon free radicals at a faster rate than the operating fluid 115. This can result in alternative functional groups being formed by the interaction of free radicals and the additive 110. This can generate less harmful reaction products and maintain the quality of the operating fluid 115 for an extended time. The additive 110 may also have a regenerative function. The additive 110 can quench free radicals, enabling them to bond with other molecules that form potentially less harmful functional groups, and then return to its original form where the additive 110 is available to quench additional free radicals in solution. The additive 110 could undergo this regenerative function multiple times. Free radicals that are quenched by the additive 110 can yield less harmful products in solution that are more reactively stable. This can disrupt propagation of free radical chain reactions in the operating fluid 115 and maintain the quality of the operating fluid 115 for an extended time.

The function of the additive 110 may decrease the formation of hydrocarbon peroxides and carboxylic acids. Decreased formation of peroxides may slow the rate of viscosity increase, and decreased formation of carboxylic acids may lower the rate of Total Acid Number (TAN) increase which can improve corrosion resistance.

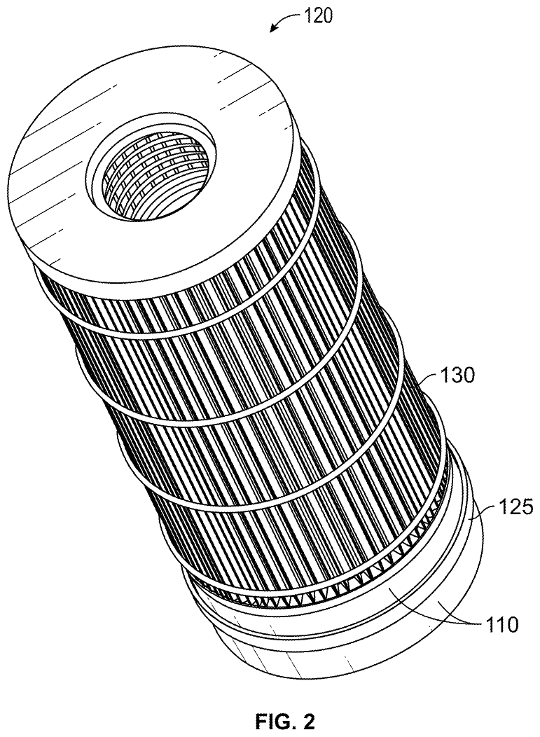

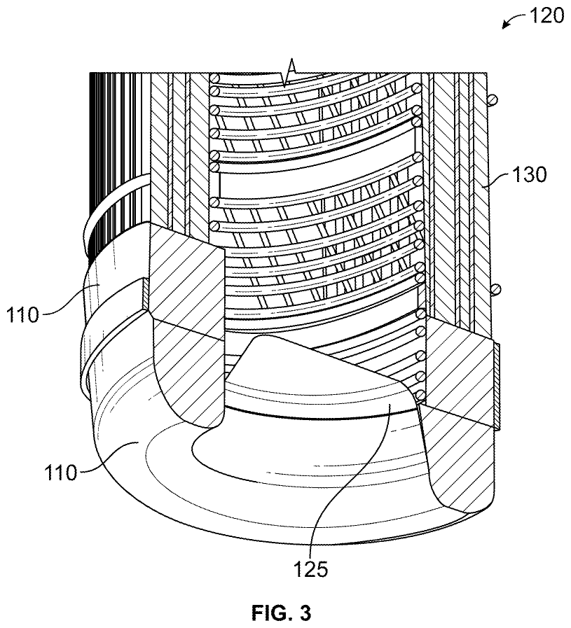

Referring again to FIG. 1, the system 100 also includes a filter element 120. FIG. 2 illustrates a perspective view of the filter element 120. FIG. 3 illustrates a cross-sectional perspective view of a lower portion of the filter element 120 of FIG. 2. The filter element 120 is disposed in the housing 105. For example, the filter element 120 can be positioned in the housing. The filter element 120 is configured to filter the operating fluid 115. The filter element includes a filter media 130. The additive 110 can be coupled with the filter media 130. For example, the additive 110 can adhere to the filter element 120. The additive 110 can be contained in any location within the filter element 120 and/or filter media 130. For example, the additive 110 can be disposed below the lower endplate, within the media, or a combination of below the lower endplate and within the media. The filter element 120 can include fibrous media. For example, the filter element 120 can include fibrous media that has been pleated, stacked, wound, corrugated, or packaged within the housing 105.

In this particular embodiment, the additive is disposed within the media. In various embodiments, the additive 110 can be captured or otherwise disposed in a fibrous matrix. For example, the additive 110 can be disposed in a fibrous media. For example, the fibrous media can be pleated, stacked, wound, or corrugated. In such an arrangement, the additive 110 can be dispersed throughout some or all of the fibrous media, for example by coating fibers of the fibrous matrix.

The additive 110 can be introduced to the filter element 120 in a liquid state.

The additive 110 can adhere to a surface of the filter element 120 when the additive 110 comes in contact with the filter element 120. Once adhered, the additive 110 can transition from a liquid state (e.g., liquid form) to a solid state (e.g., solid form). The transition from the liquid state to the solid state can allow the additive 110 to fix itself in place within the filter element 120 more securely than a gel or non-solid self-containing material could. The additive 110 can be shaped before being packaged within the filter element 120. The shape and outside texture of the additive 110 can be modified by cutting, scraping, and/or buffing. The additive 110 can be liquefied and molded into a shape. The additive 110 can be cut into shapes from a solid form. The additive 110 can be processed into a powder form. The powder can be compressed or formed into a shape.

As shown in FIGS. 2-3, the filter element 120 includes an endplate 125 at one end thereof. The additive 110 can be coupled with or otherwise positioned against the endplate 125 For example, the additive 110 can be contained below the endplate 125, i.e., the additive can take a solid form and extend from the endplate in a direction axially away from the filter media 130. The additive 110 can be contained above the endplate 125, for example by being embedded within the filter media 130 or positioned on a radially outer surface of the filter media 130.

The additive 110 can be disposed on at least one of the influent side of the filter element 120 or the effluent side of the filter element 120. The additive 110 can be contained in the influent area or effluent area surrounding the fibrous matrix.

The additive 110 can be a solid additive. The solid additive can be self-containing (e.g., self-contained, not needing a containment vessel, etc.). The self-containing aspect of the additive 110 can eliminate a need for an additive dosing vessel. The absence of a dosing vessel can allow for more media area in the filter element 120. For example, a filter element without a dosing vessel can have 40% more filter capacity than a filter element with a dosing vessel. More media area can result in higher capacity and lower restriction across the filter element 120. The absence of a dosing vessel can eliminate the need for passing any unfiltered fluid through the filter element 120. The additive 110 can improve the quality of the operating fluid.

Dosing vessels can release additive on the downstream side of the filter media. A self-contained additive chemistry could be contained on the upstream side of the filter media. The additive 110 can dissolve into fluid and pass through the filter element 120 before being introduced to the fluid system. This could lower risks of any contaminant in the additive making its way into the fluid system. The additive 110 can be added to a spin-on lube filter without the need to modify the design of the spin-on filter.

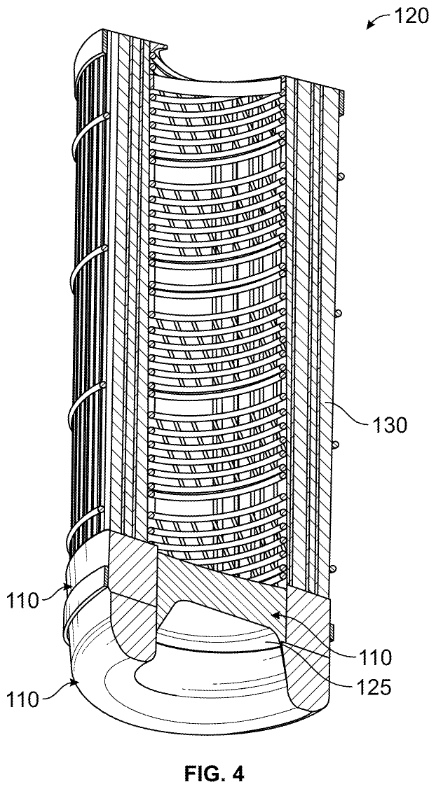

FIG. 4 illustrates a cross-sectional perspective view of the filter element 120 of FIG. 2. In the embodiment of FIG. 4, the filter element 120 includes the additive 110. In the embodiment of FIG. 4, the filter element 120 defines a hollow interior, with the additive 110 disposed within the hollow interior. The additive 110 can be dispersed throughout the hollow interior of the filter element 120.

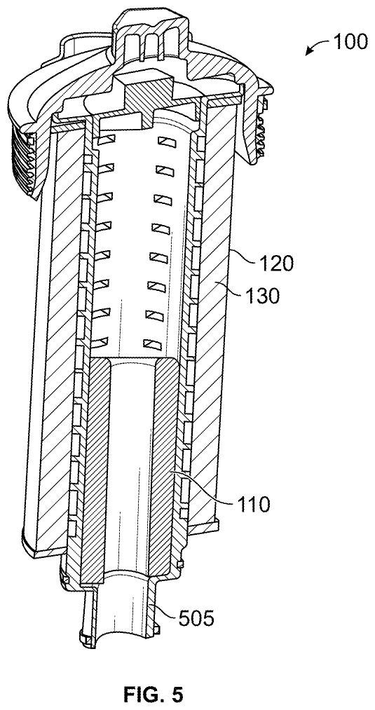

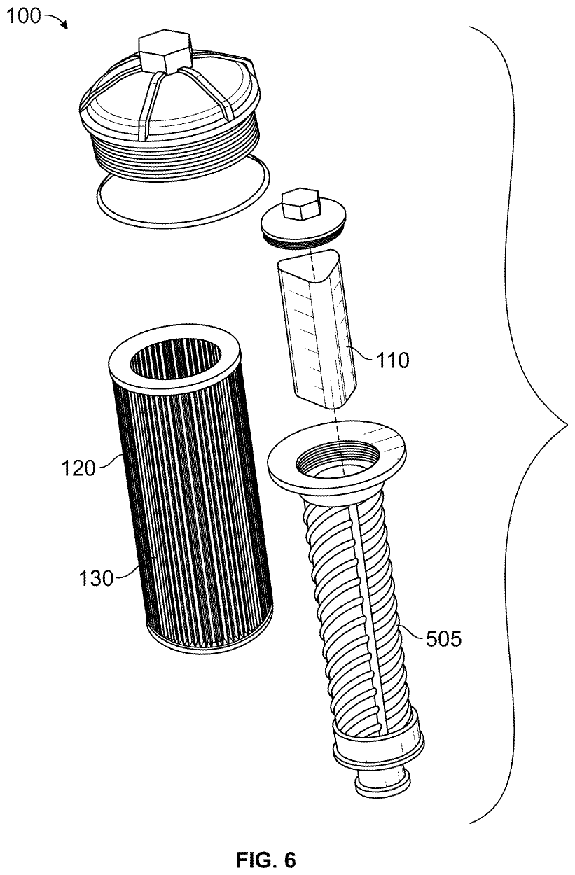

FIG. 5 illustrates a cross-sectional view of a portion of a system 500, according to another embodiment. FIG. 6 illustrates an exploded view of the system 500 of FIG. 5. In the embodiments of FIGS. 5 and 6, the system 500 includes the additive 110 and the filter element 120. The additive 110 can be any shape. The additive 110 can be molded. For example, the additive 110 can include a solid molded shape (e.g., puck). The additive 110 can be introduced to the filter element 120, a mold, or form without a solvent carrier fluid to aid in the dispensing or packaging process. The additive 110 can be inserted into the filter element 120. A width of the additive 110 can be less than the inner diameter of the filter element 120. A length of the additive 110 can be less than a length of the filter element 120.

In the embodiments of FIGS. 5 and 6, the system 500 includes a tube 505 (e.g., center tube) disposed in the filter element 120. The additive 110 can be disposed in the tube 505. In such arrangements, the outer width of the additive 110 would be less than the largest inner diameter of the tube 505.

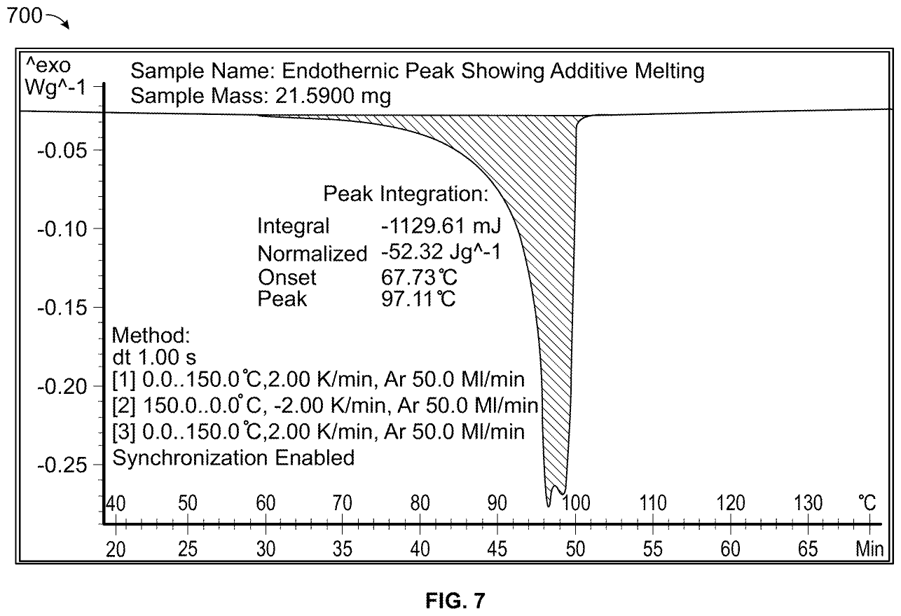

FIG. 7 illustrates a differential scanning calorimetry plot 700 of the additive 110. The additive 110 can melt between a temperature of 60° C. and 100° C. A peak 705 corresponds to an endothermic melting peak. An area 710 between the peak 705 and a baseline 715 corresponds to the enthalpy of fusion of the additive 110.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or”may indicate any of a single, more than one, and all of the described terms.

References to at least one of a conjunctive list of terms may be construed as an inclusive OR to indicate any of a single, more than one, and all of the described terms. For example, a reference to “at least one of ‘A’and ‘B’” can include only ‘A’, only ‘B’, as well as both ‘A’ and ‘B’. Elements other than ‘A’and ‘B’ can also be included.

As used herein, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

The terms “coupled,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements; values of parameters, mounting arrangements; use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes, and omissions may also be made in the design, operating conditions, and arrangement of the various exemplary embodiments without departing from the scope of the present application.

While this specification contains many specific implementation details, these should not be construed as limitations on the scope of any embodiments or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

1. A system, comprising:
a housing; and
an additive disposed in the housing, the additive configured as a crystalline solid at a temperature below 60° C. and configured to melt and disperse into the operating fluid at a temperature in a range of 60° C. to 160°C.

2. The system of claim 1, further comprising a filter element disposed within the housing.

3. The system of claim 2, wherein the additive is coupled with the filter element.

4. The system of claim 2, wherein:
the filter element comprises an endplate; and
the additive is coupled with endplate of the filter element.

5. The system of claim 2, wherein the housing comprises a centrifuge housing.

6. The system of claim 2, wherein:
the filter element defines a hollow interior; and
the additive is disposed within the hollow interior of the filter element.

7. The system of claim 2, further comprising:
a tube disposed in the filter element,
wherein the additive is disposed in the tube.

8. The system of claim 2, wherein:
the filter element comprises an influent side and an effluent side; and
the additive is disposed on at least one of the influent side of the filter or the effluent side of the filter element.

9. The system of claim 1, wherein the additive comprises docusate sodium.

10. The system of claim 1, wherein the additive comprises sodium bis(2-ethylhexyl) sulfosuccinate.

11. The system of claim 1, wherein the operating fluid comprises at least one of lube oil, hydraulic fluid, gear oil, fuel, and coolant.

12. The system of claim 1, wherein the additive comprises at least one of an aminic antioxidant, a phenolic antioxidant, an anti-wear additive, a pour point depressant, a viscosity modifier, a friction modifier, a dispersant, an over-based detergent, a weak based additive, an anti-foam additive, a corrosion inhibitor additive, or a surfactant.

13. The system of claim 1, wherein the additive is ashless.

14. The system of claim 1, wherein the additive is configured to react with hydrocarbon free radicals in the operating fluid.

15. The system of claim 1, wherein the additive comprises a powder.

16. The system of claim 1, wherein the additive is disposed in a fibrous matrix.

17. A filter element comprising:
a filter media;
an additive coupled with the filter media, the additive configured as a crystalline solid at a temperature below 60° C. and configured to melt and disperse into an operating fluid at a temperature in a range of 60° C. to 160° C.

18. The filter element of claim 17, wherein:
the filter element comprises a hollow interior; and
the additive is disposed within the hollow interior of the filter element.

19. The filter element of claim 17, further comprising:
a tube disposed in the filter element,
wherein the additive is disposed in the tube.

20. The filter element of claim 17, wherein:
the filter element comprises an endplate; and
the additive is coupled with the endplate of the filter element.

21. The filter element of claim 17, wherein:
the filter element comprises an influent side and an effluent side; and
the additive is disposed on at least one of the influent side of the filter element or the effluent side of the filter element.

22. The filter element of claim 17, wherein the additive is configured to react with hydrocarbon free radicals in the operating fluid.

23. The filter element of claim 17, wherein the operating fluid comprises at least one of lube oil, hydraulic fluid, gear oil, fuel, and coolant.
